(19) United States
(12) Patent Application Publication
(10) Pub. No.: US 2025/0183958 A1
(43) Pub. Date: Jun. 5, 2025

(54) ANTENNA PHASE ERROR COMPENSATION WITH REINFORCED LEARNING

(71) Applicant: Telefonaktiebolaget LM Ericsson (publ), Stockholm (SE)

(72) Inventors: Guoqiang Lu, Kanata (CA); Xixian Chen, Ottawa (CA); Haomin Li, Kanata (CA); Edward Mah, Kanata (CA); Jonas Karlsson, Upplands Väsby (SE)

(21) Appl. No.: 18/845,085

(22) PCT Filed: Mar. 10, 2022
(86) PCT No.: PCT/IB2022/052180

§ 371 Date: Sep. 9, 2024

(51) Int. Cl. H04B 7/06

(52) U.S. Cl. CPC H04B 7/0617

(57) ABSTRACT

Systems and methods of the present disclosure are directed to a method performed by a network node for antenna phase error compensation via reinforcement learning. The method includes initializing M Multi-Arm Bandit (MAB) models to determine M phase offsets for phase deltas of N antenna branches with dual polarization where M=N−3. The method includes selecting M phase offsets with the M MABs. The method includes applying the M phase offsets to phase(s) of at least one antenna branch during transmission. The method includes, while applying the M phase offsets, determining reward values for the M phase offsets. The method includes, based on the reward values, updating the parameters of the M MAB models.

### TECHNICAL FIELD

The present disclosure is related to antenna phase error compensation, and, more specifically, antenna phase error compensation via reinforcement learning.

### BACKGROUND

Generally, multi-antennas with dual polarization are commonly used in Long-Term Evolution (LTE) and New Radio (NR) base stations to increase the user Signal-to-Noise and Interference Ratio (SINR) through beamforming. Beamforming requires the phases of antenna branches of the same polarization to be aligned so that cohesive signal addition can be achieved at the User Equipment (UE). Phase alignment requires that antenna phase calibration be performed periodically at the base station. However, due to various reasons such as hardware cost, software complexity, etc., base stations may use certain radios with fewer branches, such as radios with four Transmit and Receive branches (4T4R), that do not have phase calibration. As a result, the phase on any branch of the radio can be anywhere between 0 and 360 degrees, which results in the beam direction also being anywhere between 0 and 360 degrees. One consequence of this arbitrary phase is that the beam directions of two polarizations could point to two different directions. This can cause various adverse effects in terms of degraded higher rank reporting by the Wireless Communication Device (WCD), lower WCD and cell throughputs, etc.

### SUMMARY

Systems and methods are disclosed herein for antenna phase error compensation using reinforcement learning. In some embodiments, a method performed by a network node (e.g., a base station) for antenna phase error compensation via reinforcement learning is proposed. The method includes initializing M sets of phase offsets, wherein each phase offset of each of the M sets of phase offsets corresponds to a difference between two phase deltas of two pairs of antenna branches from N antenna branches with dual polarization. The M sets of phase offsets are respectively associated with M sets of probability distributions. A probability distribution models a probability that a respective phase offset provides different reward values, the reward value being a function of one or more cell-wide Key Performance Indicators (KPIs) for a cell controlled by the network node. The method includes, for each of the M sets of probability distributions, respectively sampling a random first set of sample values from the set of probability distributions such that each of the first set of sample values corresponds to a respective phase offset of the set of phase offsets associated with the set of probability distributions. The method includes, for each of the M sets of probability distributions, selecting, from the set of phase offsets, a first phase offset that corresponds to a maximum sample value from the first set of sample values. The method includes, for each of the M sets of probability distributions, applying the first phase offset to one or more phases of at least one antenna branch of the N antenna branches during transmission of signals to and/or reception of signals from a plurality of Wireless Communication Devices (WCDs) served by the cell controlled by the network node. The method includes, for each of the M sets of probability distributions, while applying the first phase offset, determining a reward value for the first phase offset. The method includes, for each of the M sets of probability distributions, based on the reward value determined while applying the first phase offset, updating the parameters of the probability distribution associated with the first phase offset. As such, by choosing a proper reward, embodiments of the present disclosure will select phase offsets that result in maximum accumulated rewards by alignment of beam directions according to collective channel conditions for all WCDs in a cell.

In some embodiments, the method further includes, for each of the M sets of probability distributions, respectively sampling a random second set of sample values from the set of probability distributions such that each of the second set of sample values corresponds to the respective phase offset of the set of phase offsets associated with the set of probability distributions. The method includes selecting, from the set of phase offsets, a second phase offset that corresponds to a maximum sample value from the second set of sample values. The method includes applying the second phase offset to the one or more phases of the at least one antenna branch of the N antenna branches during transmission of signals to and/or reception of signals from the plurality of WCDs served by the cell controlled by the network node. The method includes, while applying the second phase offset, determining a reward value for the second phase offset. The method includes, based on the reward value determined while applying the second phase offset, updating the parameters of the probability distribution associated with the second phase offset.

In some embodiments, the method further includes repeating the steps of respectively sampling, selecting, applying, determining, and updating a plurality of times.

In some embodiments, the plurality of phase offsets comprise a plurality of phase offsets within a range of and including 0 to 360 degrees.

In some embodiments, the method further includes, for each of the M sets of probability distributions,

repeating the steps of respectively sampling, selecting, applying, determining, and updating for a number, X, of iterations. The method further includes, after repeating the steps of repeating the steps of respectively sampling, selecting, applying, determining, and updating X times, respectively sampling a random X-th set of sample values from the respective set of probability distributions of the M sets of probability distributions. The method further includes selecting, from the set of phase offsets, an X-th selected phase offset that corresponds to a maximum sample value from the X-th set of sample values. The method further includes initializing a set of phase sub-offsets for the X-th selected phase offset, wherein the set of phase sub-offsets are associated with a respective set of phase sub-offset probability distributions, wherein a phase sub-offset probability distribution models a probability that a respective phase sub-offset provides a maximum phase sub-offset reward value, the phase sub-offset reward value being a function of the one or more cell-wide KPIs for the cell controlled by the network node. The method further includes respectively sampling a random set of phase sub-offset sample values from the set of phase sub-offset probability distributions such that each of the set of sub-offset sample values corresponds to a respective phase sub-offset of the set of phase sub-offsets associated with the set of phase sub-offset probability distributions. The method further includes selecting, from the set of phase sub-offsets, a phase sub-offset that corresponds to a phase sub-offset sample value from the set of phase sub-offset sample values. The method further includes applying the phase sub-offset to the one or more phases of the at least one antenna branch of the N antenna branches during transmission of signals to and/or reception of signals from a plurality of WCDs served by the cell controlled by the network node. The method further includes, while applying the phase sub-offset, determining a reward value for the phase sub-offset. The method further includes, based on the reward value determined while applying the phase sub-offset, updating the parameters of the phase sub-offset probability distribution associated with the phase sub-offset.

In some embodiments, prior to respectively sampling the random X-th set of sample values from the set of probability distributions, the method comprises determining that the number of iterations X is greater than or equal to a threshold value.

In some embodiments, the one or more cell-wide KPIs comprise a quantity of WCDs of the one or more WCDs that have a rank greater than a threshold rank value, data indicative of a Downlink (DL) channel condition, and/or a number of bits carried per Resource Element (RE) for the one or more WCDs.

In some embodiments, prior to respectively sampling the random first set of sample values from the set of probability distributions, the method comprises determining that a sampling triggering condition has occurred.

In some embodiments, determining that the sampling triggering condition has occurred comprises determining that the one or more WCDs comprises a number of WCDs greater than a threshold number of WCDs.

In some embodiments, determining that the sampling triggering condition has occurred further comprises starting a timer that expires after a certain amount of time, and the method further comprises, for each of the M sets of probability distributions, repeating the steps of respectively sampling, selecting, applying, determining, and updating until the timer expires.

In some embodiments, each of the M sets of phase offsets represent a set of arms in a Multi-Armed Bandit (MAB) reinforcement learning architecture, and wherein each phase offset is separated by a degree interval Δ, wherein the plurality of phase offsets comprises 360°/Δ phase offsets.

In some embodiments, determining the reward value for the first phase offset comprises determining measurements for the one or more cell-wide KPIs and determining the reward value for the first phase offset based at least in part on the measurements for the one or more cell-wide KPIs.

In some embodiments, M=N−3.

In some embodiments, M=1 and N=4. In some embodiments, θ₀, θ₁, θ₂, and θ₃ respectively represent the phases of antenna branches 0, 1, 2, and 3 of the N=4 antenna branches with dual polarization. Polarization A phase delta Ø_{A}=Ø₀₁=θ₀−θ₁. Polarization B phase delta Ø_{B}=Ø₂₃=θ₂−θ₃. Phase offset δ_{BA}=Ø_{B}−Ø_{A} is a phase offset between phases deltas of two pairs of antenna branches 2/3 and 0/1, wherein δ_{BA} comprises a range of [0, 360° ], and wherein δ_{BA} is quantized such with interval Δ as a set of 360/Δ phase offsets with values 0, Δ, 2Δ, . . . 360−Δ.

In some embodiments, applying the first phase offset comprises applying the first phase offset to one or more phases of antenna branch 3 of the N=4 antenna branches during the transmission of the signals to and/or the reception of the signals from the plurality of WCDs.

In some embodiments, a majority of wireless devices served by the cell controlled by the network node have channels with beams that point to a same direction for the two polarizations, and, after applying the first phase offset to the one or more phases of antenna branch 3, the polarization A phase delta Ø_{A} is equal to the polarization B phase delta Ø_{B}.

In some embodiments, a majority of wireless devices served by the cell controlled by the network node have channels with beams that point to different directions for the two polarizations, and, after applying the first phase offset to the one or more phases of antenna branch 3, the polarization A phase delta Ø_{A} will be different from the polarization B phase delta Ø_{B}.

In some embodiments, M=5 and N=8 antenna branches with dual polarization. In some embodiments,

In some embodiments:
δ_{12,01} represents a phase offset for a phase delta between pairs of antenna branches 1/2 and 0/1, wherein δ_{p1,p2}=δ_{12,01}=Ø₁₂−Ø₀₁;
δ_{23,01} represents a phase offset for a phase delta between pairs of antenna branches 2/3 and 0/1, wherein δ_{p1,p2}=δ_{23,01}=Ø₂₃−Ø₀₁;
δ_{45,01} represents a phase offset for a phase delta between pairs of antenna branches 4/5 and 0/1, wherein δ_{p1,p2}=δ_{45,01}=Ø₄₅−Ø₀₁;
δ_{56,01} represents a phase offset for a phase delta between pairs of antenna branches 5/6 and 0/1, wherein δ_{p1,p2}=δ_{56,01}=Ø₅₆−Ø₀₁,
Ø_{67,01} represents a phase offset for a phase delta between pairs of antenna branches 6/7 and 0/1, wherein δ_{p1,p2}=δ_{67,01}=Ø₆₇−Ø₀₁; and
   wherein applying the first phase offset to the one or more phases of the at least one antenna branch for each of the M sets of probability distributions comprises:
adding δ_{12,01} to antenna branch 2;
adding δ_{12,01}+δ_{23,01} to antenna branch 3;
adding δ_{12,01}+δ_{45,01} to antenna branch 5;
adding δ_{12,01}+δ_{45,01}+δ_{56,01} to antenna branch 6; and
adding δ_{12,01}+δ_{45,01}+δ_{56,01}+δ_{67,01} to antenna branch 7.

In some embodiments, a network node for antenna phase error compensation via reinforcement learning is proposed. The network node is adapted to initialize M sets of phase offsets, wherein each phase offset of each of the M sets of phase offsets corresponds to a difference between two phase deltas of two pairs of antenna branches from N antenna branches with dual polarization. The M sets of phase offsets are respectively associated with M sets of probability distributions. A probability distribution models a probability that a respective phase offset provides for different reward values, the reward value being a function of one or more cell-wide Key Performance Indicators (KPIs) for a cell controlled by the network node. The network node is adapted to, for each of the M sets of probability distributions, respectively sample a random first set of sample values from the set of probability distributions such that each of the first set of sample values corresponds to a respective phase offset of the set of phase offsets associated with the set of probability distributions. The network node is adapted to, for each of the M sets of probability distributions, select, from the set of phase offsets, a first phase offset that corresponds to a maximum sample value from the first set of sample values. The network node is adapted to, for each of the M sets of probability distributions, apply the first phase offset to one or more phases of at least one antenna branch of the N antenna branches during transmission of signals to and/or reception of signals from a plurality of WCDs served by the cell controlled by the network node. The network node is adapted to, for each of the M sets of probability distributions, while applying the first phase offset, determine a reward value for the first phase offset. The network node is adapted to, for each of the M sets of probability distributions, based on the reward value determined while applying the first phase offset, update the parameters of the probability distribution associated with the first phase offset.

In some embodiments, a network node for antenna phase error compensation via reinforcement learning is proposed. The network node includes one or more transmitters, one or more receivers, and processing circuitry, wherein the processing circuitry is configured to cause the network node to initialize M sets of phase offsets, wherein each phase offset of each of the M sets of phase offsets corresponds to a difference between two phase deltas of two pairs of antenna branches from N antenna branches with dual polarization. The M sets of phase offsets are respectively associated with M sets of probability distributions. A probability distribution models a probability that a respective phase offset provides for different reward values, the reward value being a function of one or more cell-wide KPIs for a cell controlled by the network node. The processing circuitry is configured to cause the network node to, for each of the M sets of probability distributions, respectively sample a random first set of sample values from the set of probability distributions such that each of the first set of sample values corresponds to a respective phase offset of the set of phase offsets associated with the set of probability distributions. The processing circuitry is configured to cause the network node to, for each of the M sets of probability distributions, select, from the set of phase offsets, a first phase offset that corresponds to a maximum sample value from the first set of sample values. The processing circuitry is configured to cause the network node to, for each of the M sets of probability distributions, apply the first phase offset to one or more phases of at least one antenna branch of the N antenna branches during transmission of signals to and/or reception of signals from a plurality of WCDs served by the cell controlled by the network node. The processing circuitry is configured to cause the network node to, for each of the M sets of probability distributions, while applying the first phase offset, determine a reward value for the first phase offset. The processing circuitry is configured to cause the network node to, for each of the M sets of probability distributions, based on the reward value determined while applying the first phase offset, update the parameters of the probability distribution associated with the first phase offset.

In some embodiments, method performed by a network node for multi-antenna device optimization via MAB reinforcement learning. The method includes initializing M MAB models for optimization of a multi-antenna device with N antenna branches with dual polarization, wherein the M MAB models are respectively associated with M sets of compensation values, wherein each compensation value of each of the M sets of compensation values corresponds to at least one of the N antenna branches with dual polarization, wherein M=N−3. The method includes using the M MAB models to select one or more compensation values from at least one of the M sets of compensation values. The method includes applying the one or more compensation values to at least one of the N antenna branches with dual polarization.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system according to some embodiments of the present disclosure;

FIG. 2 is a diagram illustrating a 4 Transmitter/4 Receiver (4T/4R) device (e.g., a radio) with cross-polarization according to some embodiments of the present disclosure;

FIG. 3 illustrates a block diagram for antenna phase error compensation for a 4T/4R device via reinforcement learning according to some embodiments of the present disclosure

FIG. 4 illustrates a flowchart for antenna phase error compensation via reinforcement learning according to some embodiments of the present disclosure;

FIG. 5 illustrates a block diagram for fine-grained antenna phase error compensation for a 4T/4R device via reinforcement learning according to some embodiments of the present disclosure;

FIG. 6 is a data flow diagram for fine-grained antenna phase error compensation via reinforcement learning according to some embodiments of the present disclosure;

FIG. 7 is a diagram illustrating an 8 Transmitter/8 Receiver (8T/8R) device (e.g., a radio) with cross-polarization according to some embodiments of the present disclosure;

FIG. 8 illustrates a flowchart for antenna phase error compensation via reinforcement learning according to some embodiments of the present disclosure;

FIG. 9 is a schematic block diagram of a radio access node according to some embodiments of the present disclosure;

FIG. 10 is a schematic block diagram that illustrates a virtualized embodiment of the radio access node of FIG. 9 according to some embodiments of the present disclosure;

FIG. 11 is a schematic block diagram of the radio access node of FIG. 9 according to some other embodiments of the present disclosure;

FIG. 12 is a schematic block diagram of a User Equipment device (UE) according to some embodiments of the present disclosure; and

FIG. 13 is a schematic block diagram of the Wireless Communication Device (WCD) of FIG. 12 according to some other embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device (WCD): One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Typically, radios without phase calibration, such as four branch radios, suffer from performance losses due to their lack of phase alignment. In certain None-Line-of-Sight (NLOS) channel conditions, the beam directions of two polarizations may be different. In this scenario, even with Antenna Calibration (AC), the 3GPP NR codebook assumes that the beam directions of two polarizations are aligned can produce unsatisfactory results.

Systems and methods are disclosed herein that address the aforementioned and/or other challenges. In one embodiments, systems and methods of the present disclosure cast a multi-branch radio (e.g., a 4-branch radio, 8-branch radio, etc.) with uncalibrated phases as a Multi-Armed Bandit (MAB) problem in machine learning (e.g., reinforcement learning, etc.). In other words, a phase offset between radio branches (e.g., a 4-transmitter and 4-receiver (4T4R) radio, and 8T8R radio, a 12T12R radio, etc.) with cross polarization is quantized as arms in MAB formulations. Each arm in each MAB formulation can represent a certain phase difference between antenna branches.

The reward of each arm is modelled as a gaussian distribution, and cell-level Key Performance Indicators (KPIs) such as higher rank percentage and spectral efficiency can be chosen as rewards in the MAB formulation, as opposed to trying to align beam directions of two polarizations directly in conventional antenna calibration. With reinforcement learning, the phase offset which provides a higher reward will be chosen more often, therefore resulting in higher cumulative rewards. Additionally, in some embodiments of the present disclosure, a two-stage MAB with coarse and fine phase offset intervals is proposed that facilitates faster convergence without sacrificing phase offset accuracy.

It should be noted that the proposed solution focuses on optimizing end-to-end system performance directly. By selecting a proper reward, the proposed solution can align the beam directions of two polarizations according to collective channel conditions for all WCDs in a cell while the conventional antenna calibration only aligns the beams of the two polarizations at the same direction.

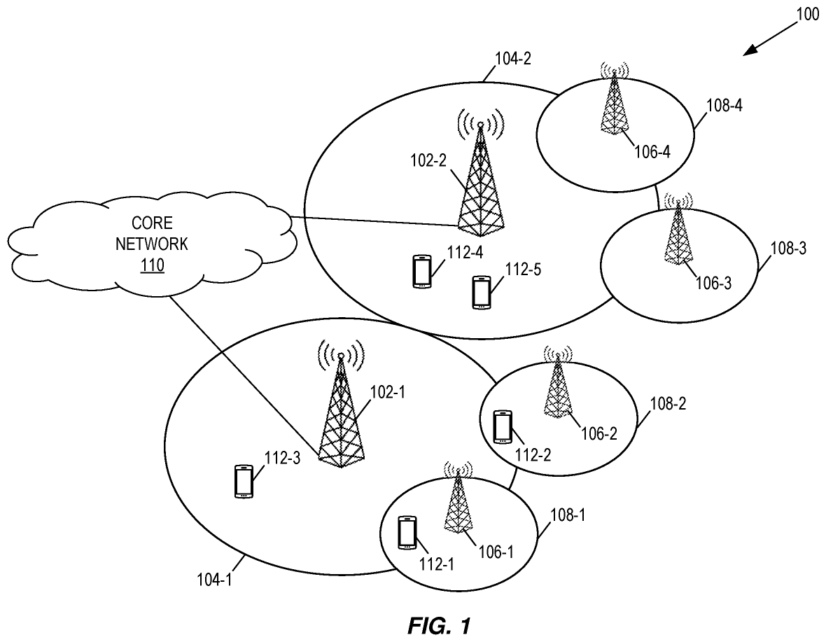

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC) or an Evolved Packet System (EPS) including an Evolved Universal Terrestrial RAN (E-UTRAN) and an Evolved Packet Core (EPC). In this example, the RAN includes base stations 102-1 and 102-2, which in the 5GS include NR base stations (gNBs) and optionally next generation eNBs (ng-eNBs) (e.g., LTE RAN nodes connected to the 5GC) and in the EPS include eNBs, controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5G System (5GS) is referred to as the 5GC. The base stations 102 (and optionally the low power nodes 106) are connected to the core network 110.

The base stations 102 and the low power nodes 106 provide service to WCDs 112-1 through 112-5 in the corresponding cells 104 and 108. The WCDs 112-1 through 112-5 are generally referred to herein collectively as WCDs 112 and individually as WCD 112.

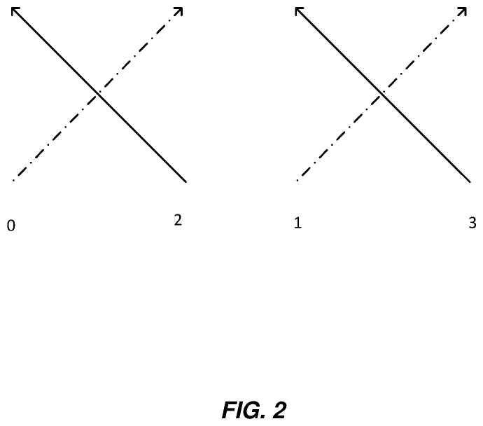

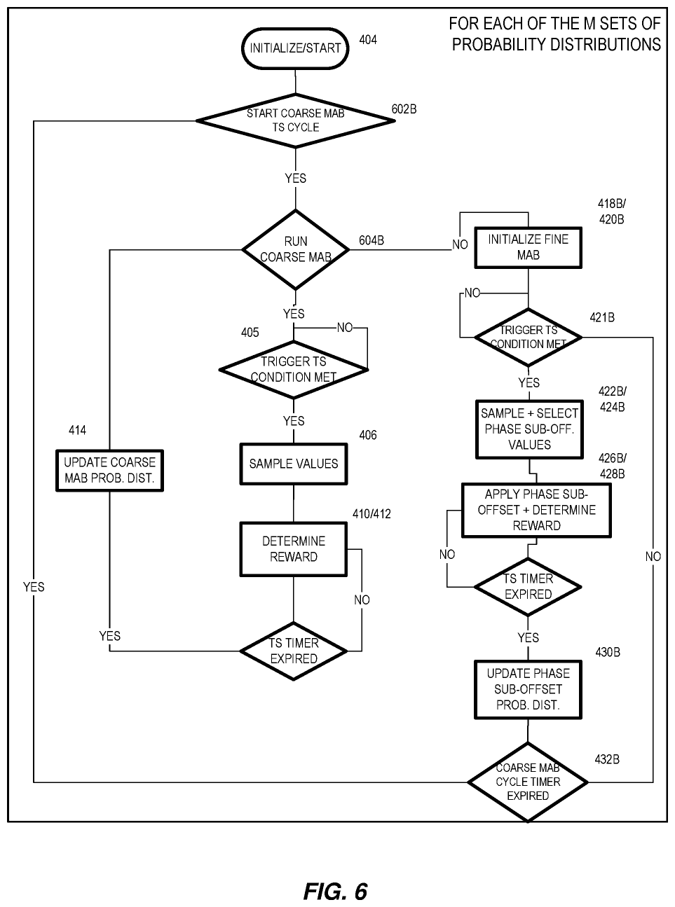

FIG. 2 is a diagram illustrating a 4 Transmitter/4 Receiver (4T/4R) device (e.g., a radio) with cross-polarization according to some embodiments of the present disclosure. Specifically, branches 0 and 1 are of polarization A, and branches 2, 3 are of polarization B. It should be noted that although a 4T/4R device is used primarily to illustrate the embodiments of the present disclosure, the present disclosure is not limited to a 4T/4R device. Rather, the embodiments of the present disclosure can be utilized for devices with any number of transceivers (TXs) (e.g., the example 8T/8R device illustrated in FIG. 6). In one embodiment, the 4T/4R device is a radio of a base station 102. The following description assumes that the 4T/4R device is a radio of a base station 102.

The phases of branches 0, 1, 2, and 3 can be respectively represented as θ_{0,1,2,3}, and Ø_{A}=θ₀−θ₁, Ø_{B}=θ₂−θ₃ represents the phase deltas for polarizations A and B, respectively. The same wireless signals transmitted on two branches of one polarization will form beams over the air with beam direction determined by the phase delta Ø_{A} or Ø_{B}. If Ø_{A}≠Ø_{B}, the beams of polarization A and B will point to different directions. For WCDs 112 with Line of Sight (LOS) signal path to the base station 102, if the two beams point to different directions, it will result in degraded DL performance. As an example, the NR 4-TX codebook for rank 2 assumes that the beams of the two polarizations point to the same direction. In this case, a phase correction is desired to make Ø_{A}=Ø_{B}.

Alternatively, for WCDs 112 that have a Non-Line of Sight (NLOS) signal path to the base station 102, the directions that give the strongest signal strength at the WCD 112 may be different for polarization A and B. In this case, it is desired that the base station 102 would send beams pointing to different directions for polarization A and B so that the signals from both polarizations will arrive at the WCD 112 with high strength. This will not be possible if the same phase compensation that makes Ø_{A}=Ø_{B} is used as in the Line of Sight (LOS) case, as a proper non-zero Ø_{B}−Ø_{A} is required.

For uncalibrated antennas, the phases of the antennas, and the phase deltas for polarizations A and B, will all generally be random. As such, the present disclosure proposes a method of compensating antenna phases to optimize cell-level downlink transmission performance. If a majority of WCDs 112 served by a base station 112 have the same beam directions for polarization A and B, the phase compensation will result in Ø_{A}=Ø_{B}. If a majority of the WCDs 112 in a cell have beams that point to different directions, the phase compensation will result in a non-zero Ø_{B}−Ø_{A}.

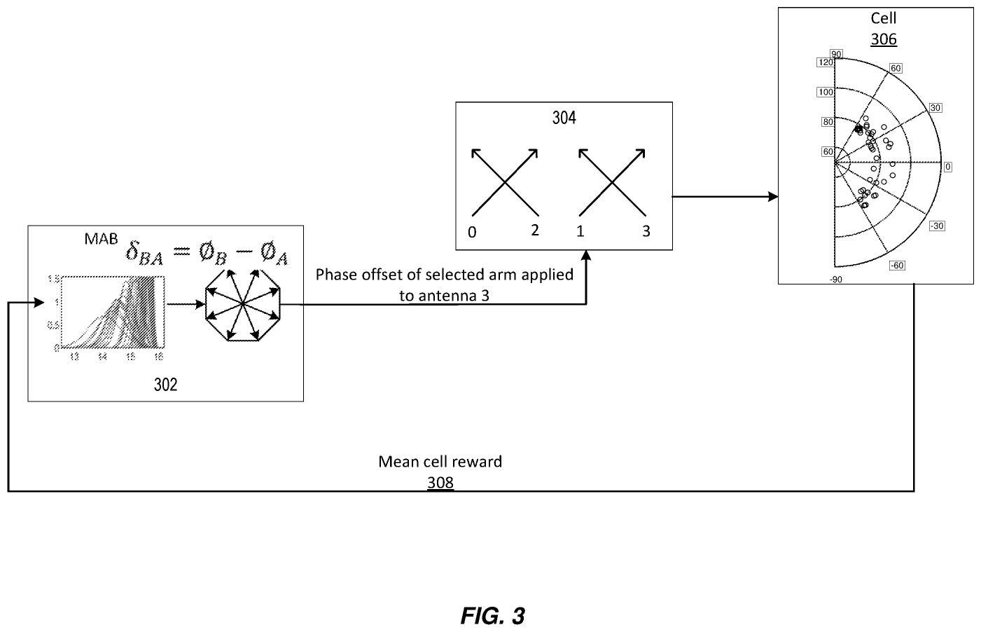

FIG. 3 illustrates a block diagram for antenna phase error compensation for a 4T/4R device via reinforcement learning according to some embodiments of the present disclosure. Specifically, FIG. 3 illustrates antenna phase error compensation for the 4T/4R device described with regards to FIG. 2. Let δ_{BA}=θ_{B}−θ_{A} represent the difference between the phase deltas of polarization B and A. The range of δ_{BA} is [0, 360° ]. δ_{BA} is then quantized with interval Δ as phase offsets with values 0, Δ, 2Δ, . . . 360−Δ. Each phase offset represents one arm in a Multi-Armed Bandit (MAB) formulation 302 with a total set of 360/Δ arms. The reward of the set of arms of the MAB 302 is modelled as a set of probability distributions (e.g., gaussian distributions, etc.) with unknown mean and known precision (i.e., variance). The reward for a selected arm can be any or a combination of cell-wide KPI such as spectral efficiency defined as a number of bits carried per Resource Element (RE), percentage of higher ranks (rank>1). Each of the set of probability distributions associated with the set of arms of the MAB 302 can be sampled (e.g., via Thompson sampling, etc.) to decide which arm is chosen from the set of arms of MAB 302. The phase offset of the chosen arm is added to the phase of one or more antenna branches of the 4T/4R device 304 (e.g., antenna branch 3). In each Thompson sampling (TS) period, all arms are sampled and the arm with the maximum sample value (i.e., reward) is chosen. The reward 308 (e.g., a mean cell reward, etc.) is then collected at the end of the TS period. The probability distribution function (PDF) of the arm that was selected is updated with the collected reward and precision of this measurement. Over time, the arms of the MAB 302 with a higher reward will have a PDF with a higher mean and a narrower distribution (smaller variance). In some embodiments, the maximum precision of the probability distributions for the arms of the MAB 302 can be limited to a precision value to allow for a certain degree of exploitation.

As an example, a first phase offset can be selected (e.g., via Thompson sampling) for application to antenna branch 3 of the 4T/4R device 304. Cell-wide KPIs can be selected from the cell 306 that serves a plurality of WCDs. Based on the KPIs, a reward value 308 (e.g., a mean cell reward value) is collected, and based on the reward value, the parameters of the probability distribution for the arm of the MAB 302 are updated. In such fashion, the MAB iteratively evaluates the phase offsets so that optimal phase offset(s) can be identified and utilized.

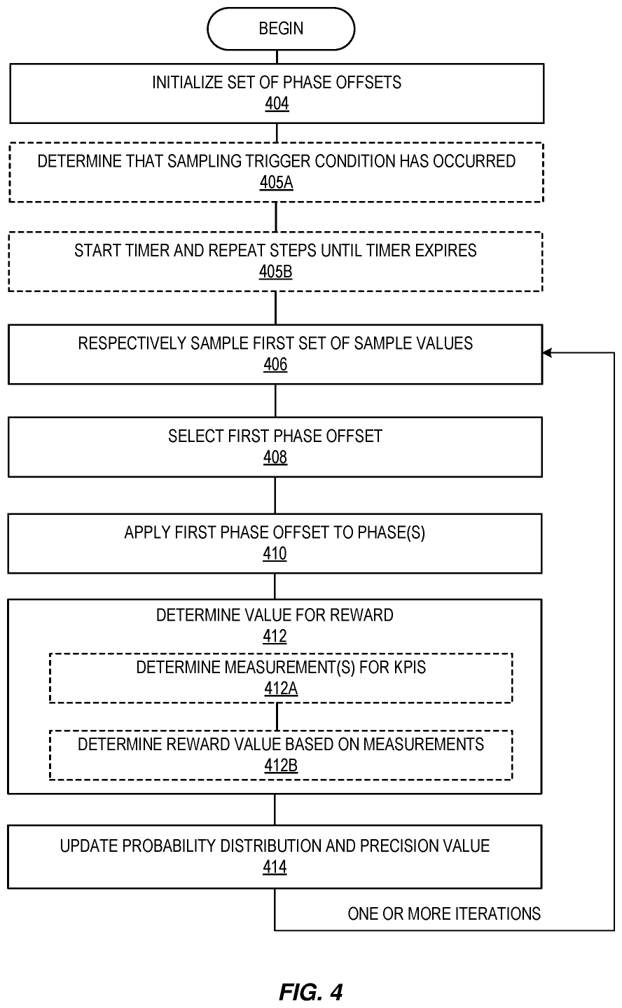

FIG. 4 illustrates a flowchart for antenna phase error compensation via reinforcement learning according to some embodiments of the present disclosure. Specifically, embodiments of the present disclosure will be described in FIG. 4 with regards to the 4T/4R device of FIG. 2 to illustrate the embodiments more clearly.

To follow the example described with regards to the 4T/4R device of FIG. 2, at step 404, a set of phase offsets is initialized that is respectively associated with a set of probability distributions (e.g., a MAB reinforcement learning architecture). Each phase offset of each of the set of phase offsets corresponds to a difference between two phase deltas of two pairs of antenna branches from 4 antenna branches with dual polarization (e.g., the number of antenna branches of a 4T/4R device). It should be noted that for a device with a number antenna branches N, a number of sets of probability distributions M will be initialized (e.g., a number of multi-arm bandit models, etc.). Generally, the number of sets of probability distributions M is equal to the number of antenna branches N−3. As such, in the case of a 4T/4R device, in which N=4, M=1 sets of probability distributions is initialized. As another example, for an 8T/8R device where N=8, the number of sets of probability distributions M would be M=N−3=5.

In some embodiments, the set of probability distributions is initialized alongside the set of phase offsets. For example, for the 4T/4R device, a set of phase offsets (e.g., arms of a MAB) can be constructed with a 360/Δ number of phase offsets with phase offset 0, Δ, 2Δ, . . . 360−Δ. The set of probability distribution (e.g., gaussian distribution functions, etc.) for the set of phase offsets is initialized with an arbitrary mean μ₀ and a low precision T₀(e.g., a large variance

$${σ}_{0}^{2} = \frac{1}{{τ}_{0}} ) .$$

In some embodiments, at step 405A, prior to step 406, the network node (e.g., node 102) determines that a sampling trigger condition has occurred. As an example, the network node 102 can determine that the one or more WCDs served by the network node 102 includes a number of WCDs greater than a threshold number of WCDs. It should be noted that sampling triggering condition can be or otherwise include any sort of network condition. For example, the sampling triggering condition may correspond to a specific time of day (e.g., a time of day associated with relatively high traffic on the network node). For another example, the sampling triggering condition may correspond to certain network quality metrics (e.g., current traffic, traffic of neighboring cells, transmission quality, etc.).

In some embodiments, at step 405B, after determining the sampling triggering condition has occurred at step 405A, the network node 102 may start a timer that expires after a certain amount of time. For example, if the number of Radio Resource Control (RRC) connected WCDs 112 in a cell controlled by the network node 102 is greater than a threshold Thresh_{Connected_UEs}, a TS timer T_{TS} can be started. In some embodiments, for the set of probability distributions, steps 406, 408, 410, 412, and 414 may be repeated until the timer (e.g., TS timer T_{TS}) expires.

At step 406, a random first set of sample values is sampled respectively from the set of probability distributions such that each of the first set of sample values corresponds to a respective phase offset of the set of phase offsets. For example, if the set of probability distributions includes 8 probability distributions, the random first set of sample values will include 8 respectively associated sample values.

At step 408, a first phase offset is selected from the set of phase offsets. The first phase offset corresponds to a maximum sample value from the first set of sample values.

At step 410, the first phase offset is applied to one or more phases of at least one antenna branch of the 4 antenna branches during transmission of signals to and/or reception of signals from the plurality of WCDs 112 served by the cell controlled by the network node 102. For example, in the case of the 4T/4R device, the phase offset of the chosen arm Δₐᵣₘ of the MAB may be added to antenna branch 3. However, it should be noted that for any number N of antenna branches, the phase offset may be applied to more than one branch. To follow the previous example, the first phase offset may be applied to both the third branch and another branch.

Specifically, for devices with N antenna branches, polarization A will have N/2−2 MABs while polarization B will have N/2−1 MABs. As such, in the case of the 4T/4R device of FIG. 2, Polarization A will have

$$\frac{4}{2} - 2 = 0$$

MABs, while Polarization B will have

$$\frac{4}{2} - 1 = 1$$

MAB (e.g., one set of phase offsets, one set of probability distributions, etc.). For example, let θ₀, θ₁, θ₂, and θ₃ represent the 4 antenna branches. The selected first phase offset δ^{p1,p2} is a phase offset between phase delta values for two pairs of antenna branches, branches Ø₂₃ (2 and 3) and Ø₀₁ (0 and 1). Thus, δ_{p1,p2}=Ø₂₃−Ø₀₁, where Ø₂₃=θ₂−θ₃ and Ø₀₁=θ₀−θ₁.

At step 412, while applying the first phase offset at step 410, the network node 102 determines a reward value for the first phase offset. In some embodiments, to determine the reward value at step 412, at step 412A the network node 102 determines measurements for the one or more cellwide KPIs. At step 412B, the reward value for the first phase offset is determined based at least in part on the measurements for the one or more cell-wide KPIs (e.g., a quantity of WCDs of the one or more WCDs that have a rank greater than a threshold rank value, data indicative of a DL channel condition, a number of bits carried per Resource Element (RE) for the one or more WCDs. For example, the chosen reward x can be determined for all WCDs:

$$x = \frac{1}{N} {\sum }_{i = 1}^{N} {x}_{i} .$$

In some embodiments, the reward value is determined until a timer expires (e.g., a timer set at step 405B, etc.).

At step 414, based on the reward value determined while applying the first phase offset at step 410, the network node updates the parameters of the probability distribution associated with the first phase offset. For example, the precision τ₀ of the probability distribution can be updated as min(τ₀+τ, τₘₐₓ), where τ₀ is the current precision of the probability distribution, and T is the precision of the current reward measurement (e.g., a specifiable metric), and the mean μ₀ of the probability distribution can be updated as:

$${μ}_{0} = \frac{{τ}_{0}}{{τ}_{0} + τ} {μ}_{0} + \frac{τ}{{τ}_{0} + τ} x .$$

The steps of 406-414 may be repeated iteratively. In some embodiments, these iterations continue until the timer started at step 405B expires. Alternatively, in other embodiments, the iterations may continue until a certain precision value is reached for one or more of the probability distributions. One or more MABs will have PDFs with high mean value and high precision. The associated phase offsets will be optimal for achieving higher downlink KPIs.

In some embodiments, a majority of wireless devices served by the cell controlled by the network node 102 may have beams that point to a same direction. To follow the example of the 4T/4R device, in such scenarios, after applying the optimal phase offset to the one or more phases of antenna branch 3 at step 410, the polarization A phase delta Ø_{A} is equal or very close to the polarization B phase delta Ø_{B}. Alternatively, in some embodiments, a majority of wireless devices served by the cell controlled by the network node 102 may have beams that point to different directions. To follow the example of the 4T/4R device, in such scenarios, after applying the optimal phase offset to the one or more phases of antenna branch 3 at step 410, the polarization A phase delta Ø_{A} is different to the polarization B phase delta θ_{B}.

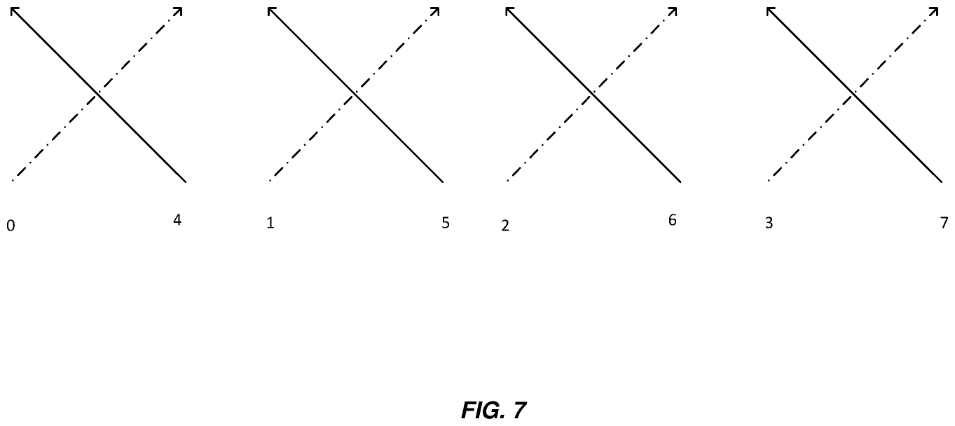

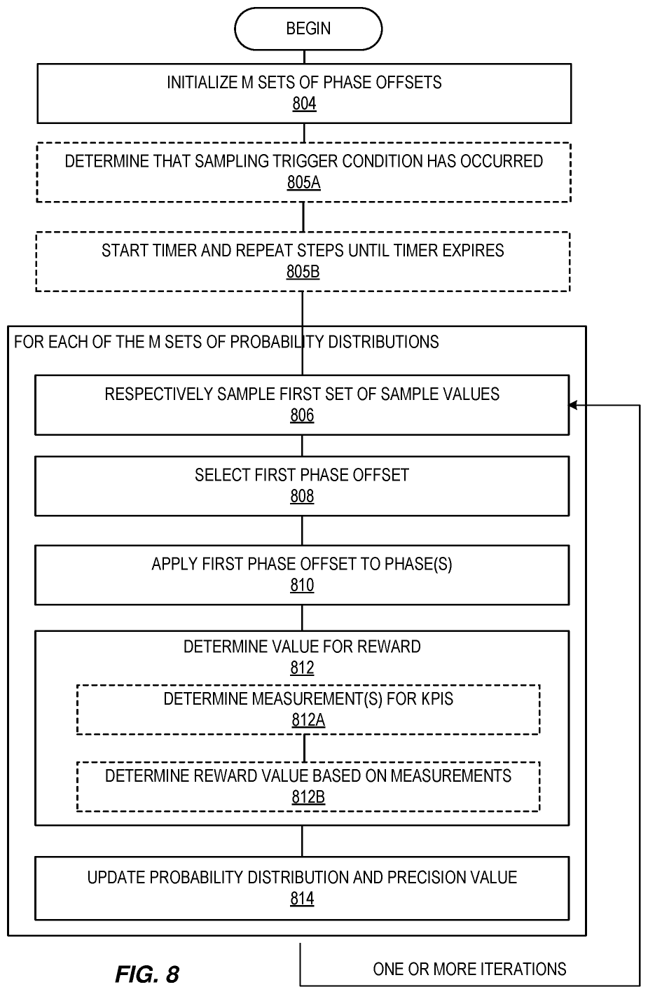

As described previously, embodiments of the present disclosure are described in FIG. 4 in the context of a 4T/4R device so that the embodiments may be described more clearly. However, the embodiments of the present disclosure may be applied to devices with any number of antenna branches. For example, in the case of an 8T/8R device with N=8 branches, M=N−3=5 sets of phase offsets and 5 respective sets of probability distributions may be initialized. For each iteration of the one or more iterations, the steps 406-414 can be performed for each of the M sets of phase offsets. Embodiments of the present disclosure with more than one set of probability distributions will be described in greater detail with regards to FIGS. 7 and 8.

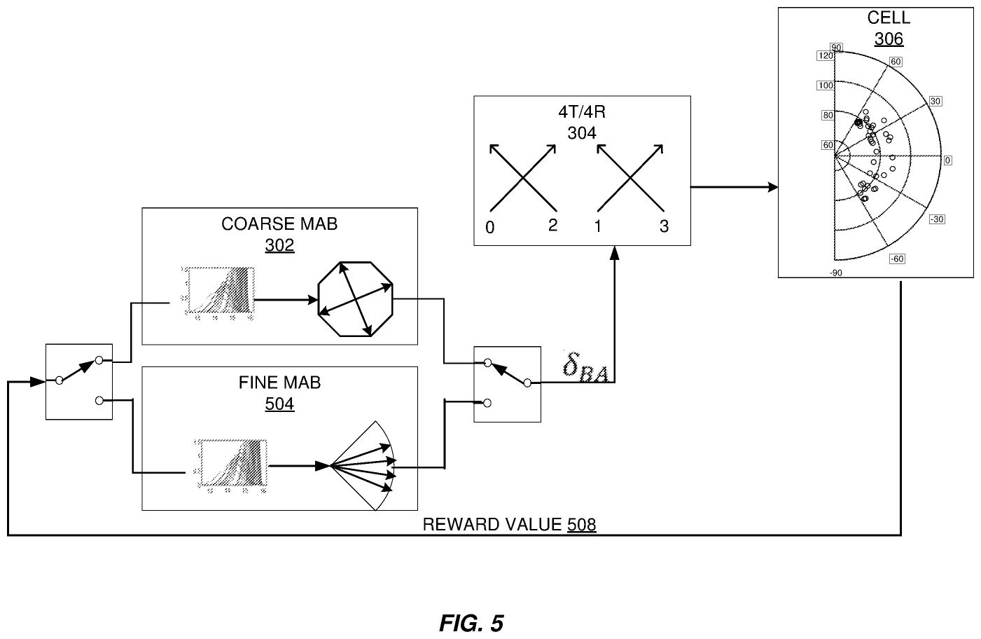

FIG. 5 illustrates a block diagram for fine-grained antenna phase error compensation for a 4T/4R device via reinforcement learning according to some embodiments of the present disclosure. Specifically, FIG. 5 illustrates a dual-MAB reinforcement learning architecture in which the output of a coarse MAB 302 (e.g., the coarse MAB 302 of FIG. 3) is refined by a fine MAB 504.

The coarse MAB 302 may function in the same manner as the MAB 302 of FIG. 3 to determine a phase offset, apply the phase offset to the 4T/4R device 304, determine a reward value based on KPIs of the cell 306, and update parameters of the associated arm of the MAB 302. After a number of iterations with the coarse MAB 302, the fine MAB 504 can be utilized to refine an optimal arm of the coarse MAB 302.

The coarse MAB 302 has a larger quantization interval Δ_{c} in the range with arms having phase offsets at 0, Δ_{c}, 2Δ_{c}, . . . 360−Δ_{c}. In some embodiments, the coarse MAB 302 and the fine MAB 504 may run in two stages for each cycle. As described previously, the coarse MAB 302 runs first for one or more iterations to find the best arm whose phase offset is denoted as δ_{c}.

As an example, the coarse MAB 302 may run for a number of iterations and until the precision value and/or sampled mean of an arm of the coarse MAB that corresponds to a phase shift of 45 degrees is above threshold value(s). Next, the fine MAB 504 may run for a number of iterations to further refine the phase offset. As the arms of the fine MAB are constructed with interval Δ_{f} in the range [δ_{C}−Δ_{c}, δ_{C}+Δ_{c}], there is necessarily less variance in the arms of the fine MAB 504 than those of the coarse MAB 302.

FIG. 6 is a data flow diagram for fine-grained antenna phase error compensation via reinforcement learning according to some embodiments of the present disclosure. Similarly, to FIG. 4, the steps of FIG. 6 are illustrated for the 4T/4R device of FIG. 2 to illustrate the example embodiments more clearly. However, the steps of FIG. 6 are not limited to these devices. More specifically, in the case of a device with a number of antenna branches N greater than 4 (e.g., 8 branches), in which a number of sets of phase offsets M=N−3 are initialized (e.g., 5 sets for 8 branches), the steps 418B-432B may be repeated for each set of phase offsets of the M sets of phase offsets.

At step 404, the network node 102 initializes the set of phase offsets as described with regard to FIG. 4. Next, in some embodiments, at step 602B the network node 102 starts the timer T_{cycle} for the coarse MAB (e.g., coarse MAB 302), and resets the counter C_{cMAB} to 0, which tracks the number of times the coarse MAB has been sampled.

As described previously, the coarse MAB will iterate a number of times X through steps 406-414 of FIG. 4. In some embodiments, at step 604B, the network node 102 determines whether to initialize the fine MAB (e.g., fine MAB 502) or to continue to iteratively perform steps 406-414. For example, a threshold Thresh_{cMAB} may have a value of X. The network node 102 may determine that the value of C_{cMAB} is X, and may then proceed to initializing the fine MAB. Alternatively, the network node 102 may determine that the value of C_{cMAB} is below X, and may then proceed to iterate through steps 406-414 again.

Specifically, in some embodiments, after repeating the steps of respectively sampling (406), selecting (408), applying (410), determining (412), and updating (414) for the X iterations, the network node 102, at step 416B, respectively samples a random X-th set of sample values from the respective set of probability distributions of a set of probability distributions. Next, at step 604B, the network node 102 determines that a condition has been satisfied to initialize the fine MAB (e.g., a certain number of iterations has occurred, etc.).

In some embodiments, at step 420B, the network node 102 initializes, for the set of probability distributions, a set of phase sub-offsets for the X-th selected phase offset. The set of phase sub-offsets is associated with a respective set of phase sub-offset probability distributions. A phase sub-offset probability distribution models a probability that a respective phase sub-offset provides different phase sub-offset reward values. The phase sub-offset reward value is a function of the one or more cell-wide KPIs for the cell controlled by the network node 102.

For example, the X-th arm δ_{C} (e.g., phase offset δ_{C}) may be the arm selected most often by the coarse MAB. Based on the phase offset δ_{C}, a 2Δ_{c}/Δ_{f}1 number of phase sub-offsets (e.g., arms) can be constructed for the fine MAB with phase offset δ_{C}−Δ_{c}+Δ_{f}, δ_{c}−Δ_{c}+2Δ_{f}, . . . , δ_{c}+Δ_{c}−Δ_{f}. In some embodiments, the phase sub-offset probability distributions (e.g., Gaussian probability distribution functions) of each arm of the fine MAB is initialized with the mean from the chosen coarse MAB and a low precision T₀(large variance

$${σ}_{0}^{2} = \frac{1}{{τ}_{0}} ) .$$

It should be noted that in some embodiments, the fine MAB can iterate a number of times to refine the selected phased offset δ_{C}, and can then return to the coarse MAB so that the coarse MAB can iterate over a second number of iterations. If the phase offset S selected after the second number of iterations is the same as the phase offset Se selected after the first number of iterations, the fine MAB may retain the previously initialized set of phase sub-offsets and phase sub-offset probability distributions, which includes any updates made to the parameters of the phase sub-offset probability distributions during the iterations of the fine MAB. By periodically returning to the coarse MAB from the fine MAB, embodiments of the present disclosure can ensure that the phase offset δ_{C} being refined at the fine MAB is the most optimal selection by the coarse MAB, and if so, may retain any refinements accomplished during previous iterations.

In some embodiments, after initializing the set of phase sub-offsets, at step 421B the network node 102 may determine that a trigger condition is met in the same manner as described with regards to step 405A/B of FIG. 4 (e.g., determining whether the number of RRC connected WCDs is greater than a threshold Thresh_{Connected_UEs}, starting a TS timer T_{TS}, etc.).

In some embodiments, at step 422B, the network node 102 respectively samples a random set of phase sub-offset sample values from the set of phase sub-offset probability distributions such that each of the set of sub-offset sample values corresponds to a respective phase sub-offset of the set of phase sub-offsets associated with the set of phase sub-offset probability distributions. In some embodiments, at step 424B, the network node 102 selects a phase sub-offset from the set of phase sub-offsets that corresponds to a phase sub-offset sample value from the set of phase sub-offset sample values.

In some embodiments, at step 426B, the network node 102 applies the phase sub-offset to the one or more phases of the at least one antenna branch of the 4 antenna branches during transmission of signals to and/or reception of signals from the plurality of WCDs 112 served by the cell controlled by the network node 102 as described with regards to FIG. 1 (e.g., applying the phase offset to antenna branch 3 of the 4T/4R device).

In some embodiments, while applying the phase sub-offset, at step 428B the network node determines a reward value for the phase sub-offset as described with regards to step 412 of FIG. 4.

In some embodiments, at step 430B the network node updates the parameters of the phase sub-offset probability distribution associated with the phase sub-offset based on the reward value. For example, the mean of the phase sub-offset probability distribution can be updated as updated as:

$${μ}_{0} = \frac{{τ}_{0}}{{τ}_{0} + τ} {μ}_{0} + \frac{τ}{{τ}_{0} + τ} x .$$

The precision τ₀ of the phase sub-offset probability distribution can be updated as min(τ₀+τ, τₘₐₓ) where τ₀ is the current precision of the phase sub-offset probability distribution and T is the precision of the reward measurement (e.g., a specifiable parameter).

As described previously, before the coarse MAB is utilized over the number of iterations, in some embodiments the coarse MAB timer can be initiated at step 602B. In some embodiments, after updating the phase sub-offset probability distribution, at step 432B the network node 102 can determine whether the coarse MAB cycle timer has expired. If the coarse MAB timer has expired, the network node 102 may return to step 604B to run one or more additional iterations of the coarse MAB. If the coarse MAB cycle timer has not expired, the network node 102 can run another iteration of the fine MAB.

FIG. 7 is a diagram illustrating an 8 Transmitter/8 Receiver (8T/8R) device (e.g., a radio) with cross-polarization according to some embodiments of the present disclosure. As described with regards to FIG. 4, in some embodiments, a device with N number of antenna branches utilizes M=N−3 MAB models. As such, in an 8T/8R scenario with N=8 antenna branches, M=N−3=5 MAB models can be utilized.

FIG. 8 illustrates a flowchart for antenna phase error compensation via reinforcement learning according to some embodiments of the present disclosure. Specifically, embodiments of the present disclosure will be described with regards to the 8T/8R device of FIG. 7 to illustrate the embodiments more clearly.

As described previously, the 8T/8R device of FIG. 7 includes N=8 antenna branches. To follow the example described with regards to the 8T/8R device of FIG. 7, at step 804, a number of M=8−3=5 sets of phase offsets are initialized that are respectively associated with M=5 sets of probability distributions (e.g., a Multi-Arm Bandit reinforcement learning architecture). Each phase offset of each of the 5 sets of phase offsets corresponds to a difference between two phase deltas of two pairs of antenna branches from N=8 antenna branches with dual polarization, which in the case of an 8T/8R device, equals 8 antenna branches.

In some embodiments, the 5 sets of probability distributions are initialized alongside the 5 sets of phase offsets. For example, for the 8T/8R device, 5 sets of phase offsets (e.g., 5 sets of arms of 5 respective MAB) can each be constructed with a 360/Δ number of phase offsets with phase offset 0, Δ, 2Δ, . . . 360−Δ. The 5 sets of probability distributions (e.g., gaussian distribution functions, etc.) for the 5 sets of phase offsets are each initialized with an arbitrary mean μ₀ and a low precision τ₀(e.g., a large variance

$${σ}_{0}^{2} = \frac{1}{{τ}_{0}} ) .$$

In some embodiments, at step 805A, prior to step 806, the network node (e.g., node 102) determines that a sampling trigger condition has occurred. As an example, the network node 102 can determine that the one or more WCDs served by the network node 102 includes a number of WCDs greater than a threshold number of WCDs. It should be noted that sampling triggering condition can be or otherwise include any sort of network condition. For example, the sampling triggering condition may correspond to a specific time of day (e.g., a time of day associated with relatively high traffic on the network node). For another example, the sampling triggering condition may correspond to certain network quality metrics (e.g., current traffic, traffic of neighboring cells, transmission quality, etc.).

In some embodiments, at step 805B, after determining the sampling triggering condition has occurred at step 805A, the network node 102 may start a timer that expires after a certain amount of time. For example, if the number of Radio Resource Control (RRC) connected WCDs 112 in a cell controlled by the network node 102 is greater than a threshold Thresh_{Connected_UEs}, a TS timer T_{Ts} can be started. In some embodiments, for each of the 5 sets of probability distributions, steps 406, 408, 410, 412, and 414 may be repeated until the timer (e.g., TS timer T_{Ts}) expires.

At step 806, for each of the 5 sets of probability distributions, a random first set of sample values is sampled respectively from the set of probability distributions such that each of the first set of sample values corresponds to a respective phase offset of the set of phase offsets associated with the set of probability distributions. As an example, in the case of the 8T/8R device of FIG. 7, 5 random first sets of sample values is sampled respectively from the 5 sets of probability distributions, and the 5 first sets of sample values correspond to the 5 sets of phase offsets.

At step 808, for each of the 5 sets of probability distributions, a first phase offset is selected from the set of phase offsets for each of the 5 MABs. The first phase offset corresponds to a maximum sample value from a respective first set of sample values.

At step 810, for each of the 5 probability distributions, the first phase offset is applied to one or more phases of at least one antenna branch of the 8 antenna branches during transmission of signals to and/or reception of signals from the plurality of WCDs 112 served by the cell controlled by the network node 102.

Specifically, with multi-branch devices, Polarization A of the antenna branches will have N/2−2 MABs, while Polarization B will have n/2−1 MABs. As described previously, each MAB models the reward corresponding to a phase offset (δ_{p1,p2}=Øₚ₁−Øₚ₂) with a normal probability distribution with unknown mean and known precision. For example, for a 4T/4R device, δ_{p1,p2}=δ_{23,01}=Ø₂₃−Ø₀₁, while Ø₂₃=θ₂−θ₃ and Ø₀₁=θ₀−θ₁. Each phase offset of a set of phase offsets refers to an offset of phase deltas between two pairs of antenna branches (p1 and p2). The phase offset is to be added to a respective antenna branch.

As such, to follow the example of the 8T/8R device of FIG. 7 with N=8 antenna branches, polarization A will have

$$\frac{N}{2} - 2 = 2$$

MABs while polarization B will have

$$\frac{N}{2} - 1 = 3$$

### MABs:

For MAB 1: δ_{p1,p2}=δ12,01=Ø₁₂−Ø₀₁
For MAB 2: δ_{p1,p2}=δ_{23,01}=Ø₂₃−Ø₀₁
For MAB 3: δ_{p1,p2}=δ_{45,01}=Ø₄₅−Ø₀₁
For MAB 4: δ_{p1,p2}=δ_{56,01}=Ø₅₆−Ø₀₁, and
For MAB 5: δ_{p1,p2}=δ_{67,01}=Ø₆₇−Ø₀₁.
   To add the calculated phase offsets to the 8 antenna branches, in some embodiments, the phase offsets can be applied in the following manner:
δ_{12,01} is added to branch 2
δ_{12,01}+δ_{23,01} is added to branch 3
δ_{12,01}+δ_{45,01} is added to branch 5
δ_{12,01}+δ_{45,01}+δ_{56,01} is added to branch 6, and
δ_{12,01}+δ_{45,01}+δ_{56,01}+δ_{67,01} is added to branch 7.

More generally, it should be understood that, for some embodiments of the present disclosure, M MABs may each model a reward for a respective phase offset δ_{p1(m),p2(m)}. Each phase offset δ_{p1(m),p2(m)} is a phase offset between phase delta values for two respective pairs of antenna branches, where the phase offset is δₚ₁(m),ₚ₂(m)=Øₚ₁₍ₘ₎−Øₚ₂₍ₘ₎. For each MAB of the M MABs, the branches of the m-th MAB correspond to a set of phase offset values 0, Δ, 2Δ, . . . 360−Δ for the phase offset δ_{p1(m),p2(m)}.

At step 812, while applying the first phase offset at step 810, the network node 102 determines a reward value for the first phase offset. In some embodiments, to determine the reward value at step 812, at step 812A the network node 102 determines measurements for the one or more cellwide KPIs. At step 812B, the reward value for the first phase offset is determined based at least in part on the measurements for the one or more cell-wide KPIs (e.g., a quantity of WCDs of the one or more WCDs that have a rank greater than a threshold rank value, data indicative of a DL channel condition, a number of bits carried per Resource Element (RE) for the one or more WCDs. For example, the chosen reward x can be determined for all WCDs:

$$x = \frac{1}{N} {\sum }_{i = 1}^{N} {x}_{i} .$$

In some embodiments, the reward value is determined until a timer expires (e.g., a timer set at step 805B, etc.).

It should be noted that in some embodiments, determination of a reward value determined for a particular probability distribution may be a function of the performance (e.g., KPI values) of a separate phase offset of a second probability distribution. For example, as described previously for an 8T/8R device, phase offset δ_{12,01} may be added to branch 2, while both phase offsets δ_{12,01}+δ_{23,01} may be added to branch 3. As such, the performance of branches 2 and 3 are affected by the offset δ_{12,01}.

At step 814, based on the reward value determined while applying the first set of phase offsets at step 810, the network node updates the parameters of the probability distributions associated with the first phase offset. For example, the mean μ₀ of the probability distribution can be updated as:

$${μ}_{0} = \frac{{τ}_{0}}{{τ}_{0} + τ} {μ}_{0} + \frac{τ}{{τ}_{0} + τ} x ,$$

the precision τ₀ of the probability distribution can be updated as min(τ₀+τ, τₘₐₓ), where τ₀ is the current precision of the probability distribution, and T is the precision of the current reward measurement (e.g., a specifiable metric).

As described previously, in some embodiments, the steps of 806-Z5114 may be repeated iteratively. In some embodiments, the iterations may continue until the timer started at step 805B expires.

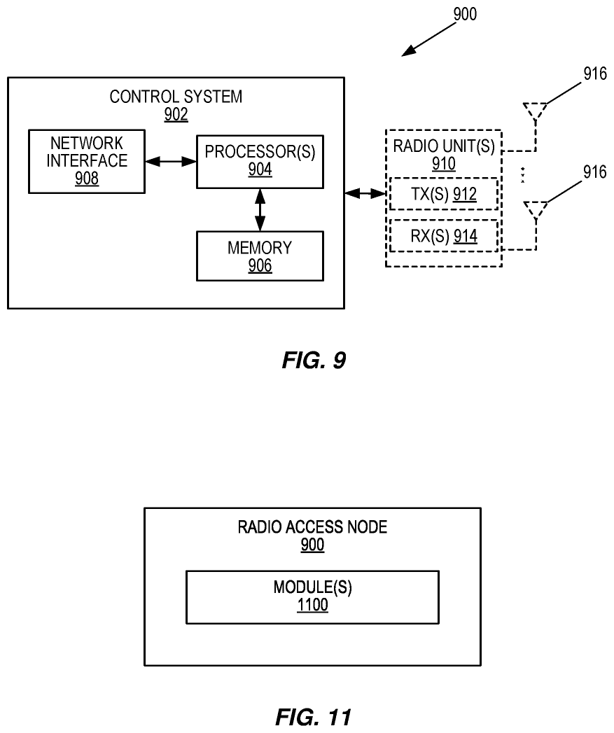

FIG. 9 is a schematic block diagram of a radio access node 900 according to some embodiments of the present disclosure illustrates. Optional features are represented by dashed boxes. The radio access node 900 may be, for example, a base station 102 or 106 or a network node that implements all or part of the functionality of the base station 102 or gNB described herein. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

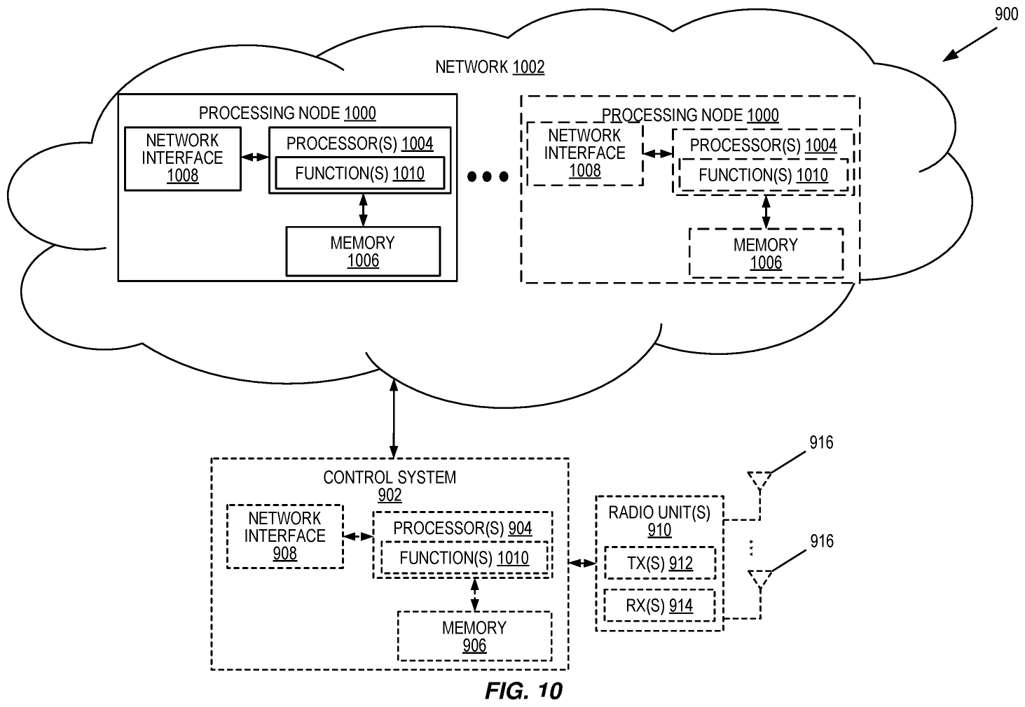

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures. Again, optional features are represented by dashed boxes.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the one or more processing nodes 1000 and the control system 902 and/or the radio unit(s) 910 in any desired manner. In some particular embodiments, some, or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

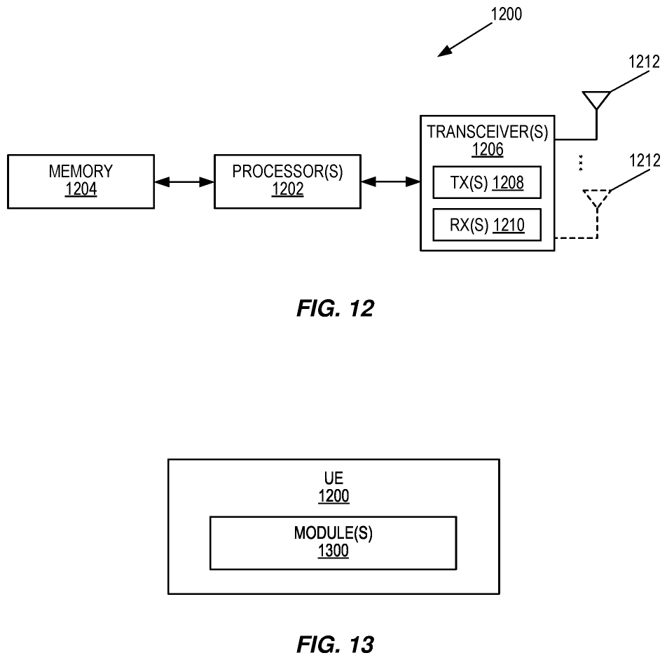

FIG. 12 is a schematic block diagram of a wireless communication device 1200 according to some embodiments of the present disclosure. As illustrated, the wireless communication device 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the wireless communication device 1200 described above may be fully or partially implemented in software that is, e.g., stored in the memory 1204 and executed by the processor(s) 1202. Note that the wireless communication device 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the wireless communication device 1200 and/or allowing output of information from the wireless communication device 1200), a power supply (e.g., a battery and associated power circuitry), etc.

In some embodiments, a computer program including instructions which, when executed by at least one processor, causes the at least one processor to carry out the functionality of the wireless communication device 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the wireless communication device 1200 according to some other embodiments of the present disclosure. The wireless communication device 1200 includes one or more modules 1300, each of which is implemented in software. The module(s) 1300 provide the functionality of the wireless communication device 1200 described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
4T/4R 4 Transmitter/4 Receiver
5G Fifth Generation
5GC Fifth Generation Core
5GS Fifth Generation System
8T/8R 8 Transmitter/8 Receiver
AC Antenna Calibration
AF Application Function
AMF Access and Mobility Function
AN Access Network
AP Access Point
ASIC Application Specific Integrated Circuit
CPU Central Processing Unit
DCI Downlink Control Information
DL Downlink
DN Data Network
DSP Digital Signal Processor
eNB Enhanced or Evolved Node B
EPC Evolved Packet Core
EPS Evolved Packet System
E-UTRA Evolved Universal Terrestrial Radio Access
FPGA Field Programmable Gate Array
gNB New Radio Base Station
gNB-DU New Radio Base Station Distributed Unit
HSS Home Subscriber Server
IoT Internet of Things
IP Internet Protocol
KPI Key Performance Indicator
LOS Line of Sight
LTE Long Term Evolution
MAB Multi-Armed Bandit
MAC Medium Access Control
MME Mobility Management Entity
MTC Machine Type Communication
NEF Network Exposure Function
NF Network Function
NLOS None-Line-of-Sight
NR New Radio
NRF Network Function Repository Function
NSSF Network Slice Selection Function
OTT Over-the-Top
PC Personal Computer
PCF Policy Control Function
PDSCH Physical Downlink Shared Channel
P-GW Packet Data Network Gateway
PMI Precoding Matrix Indicator
PRS Positioning Reference Signal
QoS Quality of Service
RAM Random Access Memory
RAN Radio Access Network
RE Resource Element
ROM Read Only Memory
RP Reception Point
RRC Radio Resource Control
RRH Remote Radio Head
RTT Round Trip Time
SCEF Service Capability Exposure Function
SINR Signal-to-Noise and Interference Ratio
SMF Session Management Function
TCI Transmission Configuration Indicator
TP Transmission Point
TRP Transmission/Reception Point
TS Thompson Sampling
UDM Unified Data Management
UE User Equipment
UPF User Plane Function
WCD Wireless Communication Device

Those skilled in the art will recognize improvements and modifications to the embodiments of the present disclosure. All such improvements and modifications are considered within the scope of the concepts disclosed herein.

1. A method performed by a network node for antenna phase error compensation via reinforcement learning, the method comprising:
initializing M sets of phase offsets, wherein each phase offset of each of the M sets of phase offsets corresponds to a difference between two phase deltas of two pairs of antenna branches from N antenna branches with dual polarization, wherein the M sets of phase offsets are respectively associated with M sets of probability distributions, wherein a probability distribution models a probability that a respective phase offset provides for different reward values, the reward value being a function of one or more cell-wide Key Performance Indicators, KPIs, for a cell controlled by the network node;
for each of the M sets of probability distributions:
respectively sampling a random first set of sample values from the set of probability distributions such that each of the first set of sample values corresponds to a respective phase offset of the set of phase offsets associated with the set of probability distributions;
selecting, from the set of phase offsets, a first phase offset that corresponds to a maximum sample value from the first set of sample values;
applying the first phase offset to one or more phases of at least one antenna branch of the N antenna branches during transmission of signals to and/or reception of signals from a plurality of Wireless Communication Devices, WCDs, served by the cell controlled by the network node;
while applying the first phase offset, determining a reward value for the first phase offset; and
based on the reward value determined while applying the first phase offset, updating the parameters of the probability distribution associated with the first phase offset.

2. The method of claim 1, wherein the method further comprises, for each of the M sets of probability distributions:
respectively sampling a random second set of sample values from the set of probability distributions such that each of the second set of sample values corresponds to the respective phase offset of the set of phase offsets associated with the set of probability distributions;
selecting, from the set of phase offsets, a second phase offset that corresponds to a maximum sample value from the second set of sample values;
applying the second phase offset to the one or more phases of the at least one antenna branch of the N antenna branches during transmission of signals to and/or reception of signals from the plurality of WCDs served by the cell controlled by the network node;
while applying the second phase offset, determining a reward value for the second phase offset; and
based on the reward value determined while applying the second phase offset, updating the parameters of the probability distribution associated with the second phase offset.

3. The method of claim 1, further comprising repeating the steps of respectively sampling, selecting, applying, determining, and updating a plurality of times.

4. The method of claim 1, wherein the plurality of phase offsets comprise a plurality of phase offsets within a range of and including 0 to 360 degrees.

5-6. (canceled)

7. The method of claim 1, wherein the one or more cell-wide KPIs comprise:
a quantity of WCDs of the one or more WCDs that have a rank greater than a threshold rank value;
data indicative of a Downlink, DL, channel condition; and/or
a number of bits carried per Resource Element, RE, for the one or more WCDs.

8. The method of claim 1, wherein, prior to respectively sampling the random first set of sample values from the set of probability distributions, the method comprises determining that a sampling triggering condition has occurred.

9. The method of claim 8, wherein determining that the sampling triggering condition has occurred comprises determining that the one or more WCDs comprises a number of WCDs greater than a threshold number of WCDs.

10. (canceled)

11. The method of claim 1, wherein, each of the M sets of phase offsets represent a set of arms in a Multi-Armed Bandit, MAB, reinforcement learning architecture, and wherein each phase offset is separated by a degree interval Δ, wherein the plurality of phase offsets comprises 360°/Δ phase offsets.

12. The method of claim 1, wherein determining the reward value for the first phase offset comprises:
determining measurements for the one or more cell-wide KPIs; and
determining the reward value for the first phase offset based at least in part on the measurements for the one or more cell-wide KPIs.

13. The method of claim 1, wherein M=N−3.

14-22. (canceled)

23. A network node for antenna phase error compensation via reinforcement learning, comprising:
one or more transmitters;
one or more receivers;
processing circuitry, wherein the processing circuitry is configured to cause the network node to:
initialize M sets of phase offsets, wherein each phase offset of each of the M sets of phase offsets corresponds to a difference between two phase deltas of two pairs of antenna branches from N antenna branches with dual polarization, wherein the M sets of phase offsets are respectively associated with M sets of probability distributions, wherein a probability distribution models a probability that a respective phase offset provides for different reward values, the reward value being a function of one or more cell-wide Key Performance Indicators, KPIs, for a cell controlled by the network node;
for each of the M sets of probability distributions:
respectively sample a random first set of sample values from the set of probability distributions such that each of the first set of sample values corresponds to a respective phase offset of the set of phase offsets associated with the set of probability distributions;
select, from the set of phase offsets, a first phase offset that corresponds to a maximum sample value from the first set of sample values;
apply the first phase offset to one or more phases of at least one antenna branch of the N antenna branches during transmission of signals to and/or reception of signals from a plurality of Wireless Communication Devices, WCDs, served by the cell controlled by the network node;
while applying the first phase offset, determine a reward value for the first phase offset; and
based on the reward value determined while applying the first phase offset, update the parameters of the probability distribution associated with the first phase offset.

24. (canceled)

25. A method performed by a network node for multi-antenna device optimization via Multi-Arm Bandit, MAB, reinforcement learning, the method comprising:
initializing M MAB models for optimization of a multi-antenna device with N antenna branches with dual polarization, wherein the M MAB models are respectively associated with M sets of phase offset values, wherein each phase offset value of each of the M sets of phase offset values corresponds to at least one of the N antenna branches with dual polarization, wherein M=N−3;
using the M MAB models to select one or more phase offset values from at least one of the M sets of phase offset;
applying the one or more phase offset to at least one of the N antenna branches with dual polarization; and
based on key performance indicators, KPIs, associated with the one or more phase offset values, updating one or more of the M MAB models.

26. The network node of claim 23, wherein the processing circuitry is further configured to cause the network node to repeat the functions of respectively sampling, selecting, applying, determining, and updating a plurality of times.

27. The network node of claim 23, wherein the plurality of phase offsets comprise a plurality of phase offsets within a range of and including 0 to 360 degrees.

28. The network node of claim 23, wherein the processing circuitry is further configured to cause the network node to, prior to respectively sampling the random first set of sample values from the set of probability distributions, determine that a sampling triggering condition has occurred.

29. The network node of claim 28, wherein determining that the sampling triggering condition has occurred comprises determining that the one or more WCDs comprises a number of WCDs greater than a threshold number of WCDs.
